(19) United States
(12) Patent Application Publication
(10) Pub. No.: US 2026/0339906 A1
(43) Pub. Date: Oct. 29, 2026

(54) HYBRID SCHEMA ARCHITECTURE FOR DATABASE MANAGEMENT

(71) Applicant: AUTOMATION ANYWHERE, INC., San Jose, CA (US)

(72) Inventors: Ruchir GUPTA, Milipitas, CA (US); James DENNIS, Milipitas, CA (US)

(21) Appl. No.: 19/631,103

(22) Filed: Mar. 27, 2026

(51) Int. Cl. G06F 16/21; G06F 16/2458

(52) U.S. Cl. CPC G06F 16/213; G06F 16/2471

(57) ABSTRACT

The present subject matter relates to managing data associated with one or more deployments in a database. The database includes a shared schema storing multi-tenant tables accessible by multiple deployments and one or more deployment-specific schemas storing deployment-isolated tables for respective deployments. Database sessions are established for clients associated with the deployments, and each session is configured with a schema resolution order identifying the shared schema and the deployment-specific schema corresponding to the deployment. During query processing, unqualified table names that do not include schema identifiers are resolved according to the schema resolution order. This approach enables shared and deployment-specific tables to coexist within a database environment in a scalable and efficient manner.

### FIELD OF INVENTION

The present disclosure relates to database management systems, and more particularly to methods and systems for a hybrid schema architecture for managing database architectures across various database environments including multi-tenant environments and/or single tenant environments.

### BACKGROUND

Enterprise software platforms that serve a large number of customers often deploy multiple regional or logical “deployments,” each supported by a separate relational database instance, such as instances of SQL Server or cloud-hosted relational database services. While this architecture can provide tenant isolation and localized data management, it also introduces several technical challenges.

For example, conventional database deployment models often require allocating database capacity on a per-tenant or per-deployment basis in advance. This approach can result in over-provisioning of resources and limited elasticity during periods of increased workload. In addition, vertically scaled relational database instances may encounter inherent scaling limitations. Scaling out typically involves provisioning additional database instances, which can lead to operational fragmentation and increased complexity when managing and querying data across multiple database systems.

In order to address these scaling and operational challenges, organizations may seek to consolidate multiple deployments into a shared or distributed database environment. However, certain application components can be difficult or impractical to adapt for multi-tenant operation. For example, scheduler systems, job processing systems, and other third-party software components frequently rely on fixed database schemas, limited configurability, and assumptions of single-tenant operation. These rigid schemas can create significant challenges when attempting to consolidate data from multiple deployments into shared infrastructure.

As a result, supporting mixed tenancy requirements can impose a substantial burden on application development. For example, application queries may require extensive rewriting to include schema qualifiers or tenant-specific identifiers. Alternatively, third-party components may need to be modified to support multi-tenant operation. Such approaches can be brittle, costly to maintain, and may require extensive modifications to application code, thereby increasing operational complexity and the potential for errors.

Additionally, many organizations require support for both cloud-based distributed database deployments and on-premises environments that continue to operate conventional single-schema databases. Maintaining separate codebases or divergent database access patterns for these different deployment modes increases development and maintenance overhead, reduces operational efficiency, and complicates system upgrades.

Accordingly, existing database deployment approaches present several technical limitations when applied to large-scale enterprise platforms serving multiple tenants. Architectures based on separate database instances per deployment can result in resource inefficiencies, operational fragmentation, and increased management complexity, while efforts to consolidate deployments into shared infrastructure may encounter compatibility issues with components designed for single-tenant schemas. In addition, approaches that require extensive query rewriting, schema modifications, or maintenance of separate code paths for different deployment environments can introduce significant development overhead, increased system fragility, latency, and greater risk of operational errors.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present subject matter, a system with hybrid schema architecture for database management is provided. The system includes a database configured to store data associated with one or more deployments, and the database includes a shared schema and one or more deployment-specific schemas. The shared schema is configured to store multiple multi-tenant tables accessible by the deployments. Each deployment-specific schema corresponds to a respective deployment from among the one or more deployments, and is configured to store one or more deployment-isolated tables for the respective deployment. The system further includes a database management system configured to establish database sessions for clients associated with respective deployments, configure each database session with a schema resolution order identifying the shared schema and the deployment-specific schema corresponding to the deployment associated with the database session, and process database queries received via the database session by resolving unqualified table names according to the schema resolution order. The resolving includes ascertaining whether the unqualified table name corresponds to a multi-tenant table stored in the shared schema, mapping the unqualified table name to the multi-tenant table stored in the shared schema when the unqualified table name corresponds to the multi-tenant table, and mapping the unqualified table name to a deployment-isolated table in the deployment-specific schema corresponding to the deployment when the unqualified table name does not correspond to the multi-tenant table stored in the shared schema.

According to another aspect of the present disclosure, a computer-implemented method for database management is provided. The method includes storing data associated with one or more deployments in a database, the database comprising a shared schema and one or more deployment-specific schemas. The shared schema is configured to store multiple multi-tenant tables accessible by the deployments. Each deployment-specific schema corresponds to a respective deployment from among the one or more deployments, and is configured to store one or more deployment-isolated tables for the respective deployment. Further, database sessions are established for clients associated with respective deployments. Each database session is configured with a schema resolution order identifying the shared schema and the deployment-specific schema corresponding to the deployment associated with the database session. Further, database queries received via the database session are processed by resolving unqualified table names, wherein an unqualified table name corresponds to a table name that does not include a schema identifier. The unqualified table names are resolved according to the schema resolution order associated with the database session. The resolving includes ascertaining whether the unqualified table name corresponds to a multi-tenant table stored in the shared schema, mapping the unqualified table name to the multi-tenant table stored in the shared schema when the unqualified table name corresponds to the multi-tenant table, and mapping the unqualified table name to a deployment-isolated table in the deployment-specific schema corresponding to the deployment when the unqualified table name does not correspond to the multi-tenant table stored in the shared schema.

According to other aspects of the present subject matter, the schema resolution order may specify that the shared schema is searched prior to the deployment-specific schema corresponding to the deployment associated with the database session. In an example, configuring the schema resolution order may comprise setting a default schema for the database session, defining one or more database objects comprising synonyms referencing tables in the shared schema and the deployment-specific schema, dynamically binding the deployment-specific schema to the database session at connection establishment, or routing database queries through an intermediary component configured to apply schema qualification to table names prior to execution of the database queries. Further, in an example, resolving the unqualified table names may be performed without performing a runtime lookup process used to determine a target schema for execution of the database query, the runtime lookup process comprising a runtime metadata lookup, a dictionary lookup, or a routing table lookup.

The described architecture provides efficiently operating a multi-tenant and/or a single tenant environment. The schema resolution order of present subject matter resolves unqualified table names between a shared schema and deployment-specific schemas, which enables consolidation of multiple deployments within a single database environment while allowing application components, including third-party subsystems, to operate without modification of database queries. The present subject matter also allows multi-tenant tables and deployment-isolated tables to coexist within the same database, thereby supporting mixed tenancy models within a shared database infrastructure. Further, schema routing is performed using session-level configuration and database-native resolution mechanisms, avoiding runtime dictionary or metadata lookup processes for determining a target schema. The approach also enables compatibility across different deployment environments, including cloud-based multi-deployment databases and legacy single-schema database configurations, thereby allowing a common application codebase to operate across such environments while simplifying operational management compared to maintaining separate database instances for each deployment. Additionally, the present subject matter may be implemented in a single-deployment environment, where the shared schema and deployment-specific schema provide for logical separation of tables while enabling database queries to reference table names without schema identifiers. Such configurations may facilitate future migration of the database to a multi-deployment architecture without requiring modification of existing application queries or database interaction logic.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a hybrid schema multi-tenancy environment, according to an example of the present subject matter.

FIG. 2 illustrates a database management system for managing data in the hybrid schema, according to an example of the present subject matter.

FIG. 3 illustrates a method for managing multi-tenant database schemas using schema resolution order, according to an example of the present subject matter.

FIG. 4 illustrates a method for resolving unqualified table names in a database query, according to an example of the present subject matter.

FIG. 5 illustrates a sequence diagram of a process for query resolution using schema search path configuration, according to an example of the present subject matter.

FIG. 6 illustrates a dual-mode configuration showing a common application codebase operating with both hybrid-schema and legacy single-schema database environments, according to an example of the present subject matter.

FIG. 7 illustrates an encoded identifier handling architecture, according to an example of the present subject matter.

### DETAILED DESCRIPTION

The present subject matter relates to database management systems and provides a hybrid schema architecture and associated techniques for managing data in database environments supporting one or more deployments.

Modern software platforms frequently support multiple deployments or tenants that access a shared database infrastructure. Conventional database architectures typically adopt either a fully multi-tenant model, in which data associated with multiple deployments is stored in shared tables and differentiated using identifiers, or an isolated deployment model in which each deployment is provisioned with a separate database instance. Fully multi-tenant designs can improve infrastructure utilization but may be difficult to apply to certain subsystems or third-party components that assume a fixed schema structure or generate database queries without schema qualification. Conversely, maintaining separate database instances for individual deployments increases operational complexity, infrastructure costs, and administrative overhead. Some approaches attempt to address these challenges by modifying application queries to include explicit schema qualifiers or by rewriting vendor components to operate within a multi-tenant schema structure. However, such approaches can be brittle, costly to maintain, and may require extensive modifications to application logic and database interaction layers. Other techniques introduce intermediary dictionary or metadata-based routing mechanisms used during query processing to identify a target schema or database object for query execution. While such mechanisms may enable shared infrastructure, they often introduce additional runtime lookup operations and increase system complexity by requiring additional components for maintaining routing metadata and performing query routing decisions, thereby increasing processing overhead and reducing scalability as the number of deployments and database objects increases.

The present subject matter provides a database architecture that enables shared and deployment-isolated data structures to coexist within a single database environment. In this context, a hybrid schema architecture refers to an arrangement in which certain tables are maintained as shared multi-tenant tables accessible by multiple deployments while other tables are maintained as deployment-isolated tables associated with respective deployments. Data associated with one or more deployments may be stored in a database comprising a shared schema storing multi-tenant tables and one or more deployment-specific schemas, each deployment-specific schema corresponding to a respective deployment and storing deployment-isolated tables associated with that deployment.

Database sessions established for clients associated with respective deployments may be configured with a schema resolution order identifying both the shared schema and the deployment-specific schema corresponding to the deployment associated with the database session. Database queries referencing unqualified table names, i.e., table names that do not include schema identifiers, may be resolved according to this schema resolution order. In operation, when a query references an unqualified table name, the database may determine whether the table name corresponds to a table stored in the shared schema. When such a correspondence exists, the table name may be mapped to the table stored in the shared schema. When the table name does not correspond to a table stored in the shared schema, the table name may be mapped to a table stored in the deployment-specific schema corresponding to the deployment associated with the database session.

Owing to such schema resolution order, shared tables and deployment-isolated tables may coexist within the same database while allowing application components to issue database queries referencing table names without schema identifiers. Because table resolution occurs through schema resolution behavior configured for the database session, query execution may rely on database-native mechanisms rather than external routing layers or metadata services.

Thus, the present subject matter also enables consolidation of multiple deployments within a single database environment while allowing application components, including third-party subsystems that assume fixed schema structures, to operate without requiring modification of database queries. In addition, table resolution based on session-level schema configuration avoids the need for runtime dictionary or metadata lookup processes typically used for query routing, thereby reducing query routing latency and improving the efficiency of database query execution.

The hybrid schema architecture therefore supports mixed tenancy models in which multi-tenant tables and deployment-specific tables coexist within the same database infrastructure. This approach simplifies operational management compared to maintaining separate database instances for each deployment and allows database environments to scale more efficiently. Further, by allowing multiple deployments to share tables while maintaining deployment-isolated tables where required, the present subject matter improves utilization of database infrastructure resources. Additionally, the separation of shared schemas and deployment-specific schemas enables independent management of shared and deployment-isolated tables, thereby simplifying schema updates and database evolution.

In some implementations, the architecture may also be used in single-deployment environments to logically organize database tables while preserving compatibility with database queries referencing unqualified table names, thereby facilitating potential future migration to multi-deployment database configurations without requiring modification of existing application queries.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processor and memory resources. For example, one or more embodiments described herein may be implemented, in whole or in part, on computing devices such as servers, desktop computers, and other portable devices. Memory, processing, and network resources may all be used in connection with the establishment, use, or performance of any embodiment described herein, including with the performance of any method or with the implementation of any system.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable memory storage units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program

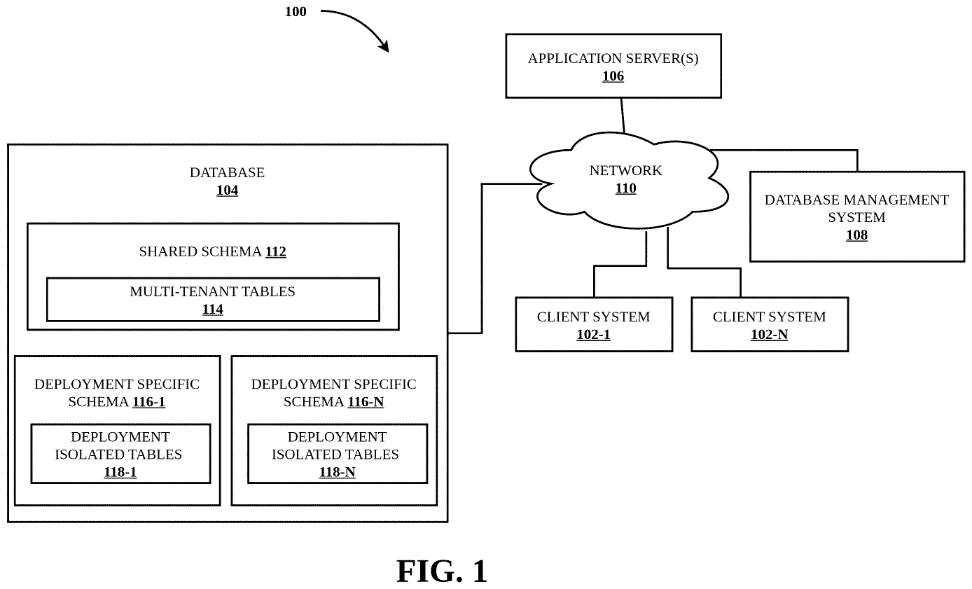

FIG. 1 illustrates, in an example embodiment, a system 100 for managing data associated with one or more deployments using a hybrid schema architecture within a database environment. The database environment may include a computing environment in which one or more database systems are used to store, manage, and access data associated with applications, services, or deployments operating within a platform. The database environment may include differing database configurations, database technologies, deployment models, or tenancy models within a common platform or architecture. Such differences may include, by way of example and not limitation, variations in database engines, database schemas, tenancy models (e.g., single-tenant, multi-tenant, or mixed-tenancy configurations), or deployment environments such as cloud-based systems, distributed database systems, or on-premises database infrastructures. In an example, the database environment may include both cloud-based database deployments and on-premises database deployments supported by a common application platform. In such implementations, certain tenants may operate using cloud-hosted distributed databases while other tenants continue to operate using conventional single-schema relational databases deployed within customer-controlled infrastructure.

The system 100 may include one or more client systems 102-1-102-N, collectively referred to as client systems 102, a database 104, one or more application servers 106, and a database management system 108, each of which may be communicatively coupled through a network 110. The network 110 may represent one or more communication networks that facilitate data exchange among the components of the system 100. In some implementations, the network 110 may include local area networks, wide area networks, wireless networks, cloud networks, or other distributed communication infrastructures. The network 110 may enable communication between the client systems 102, the application servers 106, the database management system 108, and the database 104, thereby allowing requests from the client systems to be processed by application components and corresponding data operations to be performed within the database environment.

The client systems 102 may represent computing devices or computing environments associated with users, organizations, or service consumers that access application services provided by the system 100. In various implementations, a client system 102 may include devices such as personal computers, mobile devices, workstations, or other computing systems capable of communicating with the application servers 106 through the network 110. In some implementations, the client systems 102 may be associated with respective tenants of a shared computing platform. As used herein, a tenant may refer to a logical organizational entity, service instance, or deployment environment that utilizes computing resources of the system 100. Each tenant may correspond to a customer, organization, or service environment that accesses application services and stores data within the database 104. Multiple client systems 102 may be associated with a particular tenant, and a tenant may operate within the shared infrastructure of the system 100 while maintaining logical separation of data and operations from other tenants supported by the platform.

The database 104 may represent any suitable data storage system capable of storing structured or semi-structured data associated with one or more deployments. In various implementations, the database 104 may include a relational database management system, a distributed database system, a cloud-hosted database service, or other data storage technologies capable of supporting schema-based data organization. The database 104 may be configured to store application data, metadata, configuration data, or other information associated with the operation of the system 100.

In some implementations, the database 104 may be organized using a hybrid schema architecture that includes both shared database structures and deployment-specific database structures. In such an arrangement, the database 104 may include a shared schema 112 and one or more deployment-specific schemas 116-1-116-N, collectively referred to as deployment-specific schema(s) 116. The shared schema 112 may store one or more multi-tenant tables 114 that are accessible by multiple deployments supported by the system 100. In contrast, each deployment-specific schema 116 may correspond to a respective deployment and may store one or more deployment-isolated table(s) 118 associated with that deployment. The deployment-specific schemas 116 may therefore store data structures that are logically isolated for individual deployments, while the shared schema 112 may store data structures that are shared across multiple deployments. In this manner, the database 104 may support a hybrid schema architecture in which shared multi-tenant tables 114 and deployment-isolated tables 118 coexist within the same database environment.

The database 104 may be configured to store data associated with multiple deployments within a shared database infrastructure. In some implementations, the database 104 may be implemented as a distributed relational database system or distributed SQL database cluster capable of supporting horizontally scalable storage and processing of structured data. For example, the database 104 may support features such as ACID-compliant transactions, serializable isolation levels, active-active availability, and rolling upgrades without service interruption. In certain implementations, the database 104 may be compatible with relational database interfaces such as PostgreSQL or similar relational database systems.

In some implementations, the distributed database infrastructure may be deployed across multiple geographic regions or availability zones, such as regional multi-availability-zone clusters aligned with application deployment topology. Such configurations may reduce latency for deployments operating in different geographic regions and may support data residency or regulatory requirements associated with particular deployments.

In some implementations, the hybrid schema architecture may further support data privacy and data residency compliance requirements by enabling personally identifiable information (PII) and other regulated data categories to be stored within deployment-specific schemas 116 that are pinned to database infrastructure located within a particular geographic region associated with the corresponding deployment. In multi-region distributed database configurations, data privacy regulations may require that certain categories of data, such as PII, remain within designated geographic boundaries. By designating tables containing PII or other region-sensitive data as deployment-isolated tables 118 within the deployment-specific schemas 116, and by aligning each deployment-specific schema 116 with database infrastructure residing within the applicable geographic region, the system 100 may ensure that regulated data remains within designated regional boundaries without requiring separate database instances for each deployment. In the absence of such an architecture, compliance with data residency requirements in a multi-tenant database environment may require provisioning of fully independent database instances per region, which may increase operational expenditure and infrastructure costs. In contrast, the hybrid schema architecture described herein may enable non-regulated application data to be consolidated within the shared schema 112 as multi-tenant tables 114, while PII and other region-sensitive data may be isolated within region-aligned deployment-specific schemas 116, thereby reducing both operational expenditure and cost of goods sold associated with maintaining compliant multi-region database deployments while preserving application simplicity through the use of unqualified table name resolution as described herein.

In some implementations, access to the database 104 may occur through one or more application servers 106, which may host application components configured to receive requests from the client systems 102, perform application processing, and interact with the database 104 to retrieve, store, or modify data. The application servers 106 may therefore provide an intermediary application layer through which requests originating from the client systems 102 are processed before corresponding data operations are performed within the database 104. In some implementations, the application servers 106 may operate using a common application codebase capable of interacting with database environments that support multiple deployments.

As noted above, the application servers 106 may interact with the database 104 to perform data retrieval and modification operations associated with requests received from the client systems 102. In some implementations, such database interactions may be managed by the database management system 108, which may control database operations associated with the database 104, including database session management, query processing, and schema-related operations. The database management system 108 may therefore enable application components executing on the application servers 106 to access and manipulate data stored within the database 104.

In an example, the system 100 may support database environments in which data associated with multiple deployments is consolidated within a shared database infrastructure. Within such environments, certain data structures may be maintained as shared multi-tenant tables 114 within the shared schema 112, while other data structures may remain isolated within the deployment-specific schemas 116 associated with respective deployments. As described in greater detail with reference to subsequent figures, database sessions associated with respective deployments may be configured such that database queries referencing table names without schema identifiers are resolved to either shared tables or deployment-specific tables depending on the context of the request.

Through this hybrid schema arrangement, the system 100 may enable multiple deployments to operate using shared database infrastructure while preserving logical isolation for deployment-specific data structures. In some implementations, database sessions associated with respective deployments may be configured with a schema resolution order, such as a schema search path in which the shared schema 112 is searched prior to the corresponding deployment-specific schema 116, thereby enabling database queries referencing table names without schema identifiers to be resolved to either shared multi-tenant tables 114 or deployment-isolated tables 118 based on the configured search order. Such an approach may allow application components to access shared and deployment-specific data structures without requiring modification of database queries while improving scalability and resource utilization and reducing operational complexity compared to architectures that maintain separate databases for each deployment.

In an example, application components executed by the application server 106 may operate using a common application codebase capable of interacting with both hybrid-schema database environments and legacy single-schema database environments. These different database configurations may be referred to as a distributed database mode (or distributed hybrid database mode) and a legacy database mode, respectively. In the distributed database mode, database sessions may be configured with a schema resolution order including the shared schema 112 and the deployment-specific schema 116 corresponding to the deployment associated with the session. In the legacy database mode, database sessions may be configured to access a single schema containing tables associated with a deployment. Supporting both the distributed database mode and the legacy database mode may allow applications originally designed for single-schema databases to operate within hybrid schema database environments without requiring modification of application queries or database interaction logic. This capability may simplify migration of existing systems to shared database infrastructures while maintaining compatibility with legacy deployments.

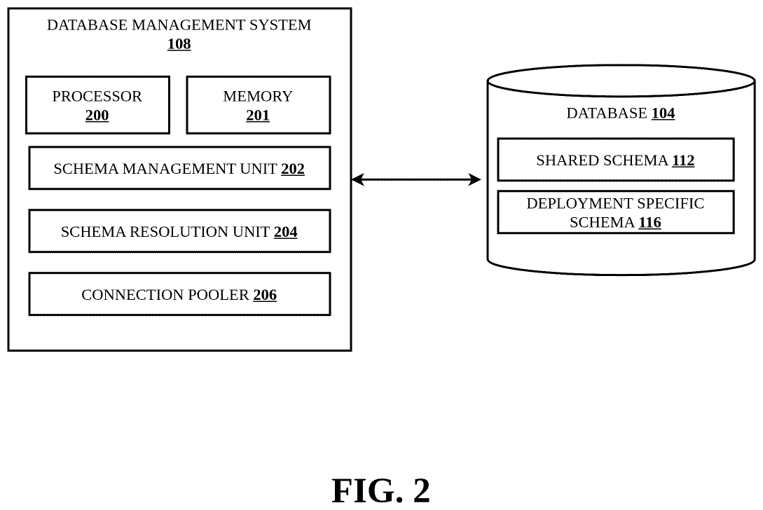

FIG. 2 illustrates, in an example embodiment, components of the database management system 108. The database management system 108 may be configured to manage database sessions, process database queries, and control schema resolution behavior for database sessions associated with different deployments supported by the system 100. As mentioned earlier, database queries processed by the database management system 108 may originate from application components such as the application server 106 described with reference to FIG. 1. The application server 130 may generate database queries using a common application codebase and transmit those queries to the database management system 108 for execution against the database 104.

The database management system 108 may be implemented on one or more server devices, and includes processor 200, memory 201 which may include a read-only memory (ROM) as well as a random-access memory (RAM) or other dynamic storage device, and communication interface (not shown in figures) for communicative coupling to network 110. Processor 200 is configured with software and/or other logic to perform one or more processes, steps and other functions described with implementations, such as described by FIGS. 1 through 4 herein. Processor 200 may process information and instructions stored in memory 201, such as provided by a random-access memory (RAM) or other dynamic storage device, for storing information and instructions which are executable by processor 200. Memory 201 also may be used for storing temporary variables or other intermediate information during execution of instructions to be executed by processor 200. Memory 201 may also include the ROM or other static storage device for storing static information and instructions for processor 200; a storage device, such as a magnetic disk or optical disk, may be provided for storing information and instructions. The database management system 108 may include instructions stored in RAM of memory 201, and includes a schema management unit 202, a schema resolution unit 204, and a connection pooler 206. These components may cooperate to establish and maintain the hybrid schema architecture within the database 104, configure schema resolution behavior for database sessions associated with respective deployments, and manage database connections used to execute database queries.

The schema management unit 202 may be configured to establish and maintain a hybrid schema architecture within the database 104. In some implementations, the schema management unit 202 may generate a shared schema 112 configured to store multi-tenant tables accessible by multiple deployments supported by the system 100. The shared schema 112 may store a plurality of multi-tenant tables 114 containing application data common across multiple deployments. The schema management unit 202 may further generate one or more deployment-specific schemas 116, each deployment-specific schema corresponding to a respective deployment and configured to store deployment-isolated tables associated with that deployment. The deployment-specific schemas 116 may store deployment-isolated tables associated with respective deployments. In some implementations, deployment-isolated tables may include tables that cannot be easily converted to multi-tenant structures due to architectural constraints or vendor-controlled schemas

By way of example, the shared schema 112 may store tables that contain data structures common across multiple deployments. Such tables may include user account tables, customer or tenant information tables, product catalog tables, subscription or billing tables, audit log tables, configuration tables, or other application tables whose structure and usage are substantially consistent across deployments. In contrast, the deployment-specific schemas 116 may store tables associated with components that require deployment-level isolation. Such tables may include scheduler tables, job execution tables, background task management tables, integration configuration tables, or other subsystem tables having rigid or vendor-controlled schemas. For instance, job scheduling frameworks such as Quartz-style schedulers may rely on fixed table layouts and assumptions of single-deployment operation, making such tables unsuitable for storage in shared multi-tenant tables 114. By storing such tables in the deployment-specific schemas 116 while maintaining other application tables in the shared schema 112, the system 100 may enable consolidation of shared application data while preserving isolation for components that require deployment-specific storage.

In some implementations, a majority of application tables within the database 104 may be stored within the shared schema 112, while a smaller subset of tables may be maintained within the deployment-specific schemas 116. For example, in certain implementations approximately ninety percent of application tables may reside within the shared schema 112, with the remaining tables stored within the deployment-specific schemas 116. Concentrating a majority of tables within the shared schema 112 may allow application data associated with multiple deployments to be consolidated into shared multi-tenant tables 114, thereby improving storage efficiency and simplifying database management. At the same time, maintaining a smaller subset of deployment-isolated tables within deployment-specific schemas 116 may allow components that require fixed schema structures or deployment-specific isolation to operate without modification, thereby enabling consolidation of deployment databases into a shared database infrastructure while preserving compatibility with existing subsystem components.

Further, during provisioning of a new deployment, the schema management unit 202 may create a deployment-specific schema associated with that deployment and may populate the deployment-specific schema with tables determined to require deployment-level isolation.

In an example, records stored within the multi-tenant tables 114 of the shared schema 112 may be identified using deployment-aware encoded database identifiers generated by the schema management unit 202 by encoding application identifiers with deployment identifiers associated with respective deployments. For example, a primary key stored in a multi-tenant table may be generated by combining an application-level identifier with a deployment identifier corresponding to the deployment from which the record originates. In certain implementations, such encoded identifiers may be generated using deterministic encoding techniques that combine the original application identifier, a deployment identifier, and distribution bits using bit-manipulation operations to produce a single encoded integer identifier. The distribution bits may be configured to spread records evenly across distributed database key ranges, thereby avoiding hotspots in the distributed database infrastructure. In some implementations, the bit layout may be chosen such that encoded identifiers are well-distributed across the keyspace of a distributed SQL cluster, reducing node or range hotspots for high-traffic deployments. In some implementations, identifier encoding may occur at a persistence boundary between application logic and the database 104, such as within an object-relational mapping (ORM) framework or data access layer used by the application server 106. Performing the encoding at the persistence boundary may allow application components to continue using simple application-level identifiers while the encoded identifiers stored in the database embed deployment context within the identifier while remaining compatible with database indexing and primary-key constraints.

Encoding identifiers in this manner may allow records associated with multiple deployments to coexist within the shared multi-tenant tables 114 while preventing identifier collisions between deployments. For example, when deployment databases are consolidated into the database 104, application identifiers that may otherwise overlap across deployments can be distinguished through the embedded deployment identifier within the encoded key. This approach may allow the shared schema 112 to store records from multiple deployments within the same tables without requiring modification of application-level identifier semantics. In addition, because the encoding and decoding of identifiers may occur transparently at the persistence boundary, application business logic and database queries may continue to operate using application-level identifiers while the encoded identifiers are maintained within the database. In some implementations, when records are read from the database, the ORM or data access layer may decode the encoded database identifiers back to the original application identifiers. In this manner, application business logic and upper layers may remain oblivious to the encoding and may continue to operate using simple application-level identifiers without awareness of the underlying encoded representation stored in the database.

In an example, the deployment-specific schemas 116 may retain local identifiers generated within the respective deployments for tables that are stored exclusively within those schemas. Because such tables store data isolated to a single deployment, identifier collisions between deployments may be irrelevant in those contexts. In certain situations, however, deployment-specific tables may reference tables stored in the shared schema 112. In such cases, encoded identifiers corresponding to the shared tables may be stored in the deployment-specific tables to maintain referential integrity across schemas. This approach may therefore allow shared tables to use encoded identifiers to prevent cross-deployment collisions while allowing deployment-specific tables to retain locally generated identifiers where isolation makes such collisions irrelevant, thereby enabling consistent identifier handling across both shared multi-tenant tables and deployment-isolated tables within the hybrid schema architecture.

The deployment-specific schemas 116 may be named, for instance, according to a naming convention that includes the identifier of the associated deployment. For example, a deployment-specific schema corresponding to deployment identifier A may be named private_A, while a deployment-specific schema corresponding to deployment identifier B may be named private_B. Using a naming convention that incorporates the deployment identifier may simplify schema management and enable the schema resolution unit 204 to dynamically configure schema resolution orders for database sessions associated with respective deployments.

From time to time, updates may need to be applied to the schemas in the database 104. In an example, the schema management unit 202 may implement, or integrate with, a schema management tool capable of applying schema changes across both the shared schema 112 and the deployment-specific schemas 116. For example, a first set of changesets representing common schema updates may be applied to the shared schema 112, while a second set of changesets representing component-specific schema updates may be applied to each deployment-specific schema 116 associated with respective deployments. In some aspects, the system 100 may integrate with schema management tools for applying schema changes across shared and deployment-specific schemas in a consistent manner. Such schema management tools may include tools such as Liquibase or similar schema migration frameworks capable of managing database schema evolution across multiple schemas.

Applying schema updates in this manner may allow schema changes to be deployed consistently across multiple deployments while preserving isolation for deployment-specific tables. In some implementations, the schema management tool implemented or coordinated by the schema management unit 202 may support governance mechanisms such as codeowner controls, approval workflows, or review policies for database changes, thereby maintaining consistency and control over schema modification across the shared schema 112 and the deployment-specific schemas 116. Applying schema updates in this manner may allow schema changes to be deployed consistently across multiple deployments while preserving isolation for deployment-specific tables.

Once the hybrid schema structure is established in the database 104, the schema resolution unit 204 may configure a schema resolution order for database sessions managed by the database management system 108. The schema resolution order may define an ordered set of schemas that the database engine should consult when resolving table names referenced in database queries executed within a database session.

In an example, the schema resolution order may include the shared schema 112 and the deployment-specific schema 116 corresponding to the deployment associated with the database session. During operation, the application server 106 may issue database queries to the database management system 108. In many cases, such queries may reference tables using unqualified table names, which are table names that do not include an explicit schema identifier. Resolution of such table references may therefore rely on the schema resolution order configured for the database session.

In certain implementations, the schema resolution order may specify that the shared schema 112 is searched prior to the deployment-specific schema 116. For example, when a database session is established for a deployment having identifier “A,” the schema resolution unit 204 may configure the schema resolution order such that the shared schema 112 is searched first, followed by the deployment-specific schema associated with deployment “A.” Similarly, when a database session is established for a deployment having identifier “B,” the schema resolution order may specify that the shared schema 112 is searched first, followed by the deployment-specific schema associated with deployment “B.” Accordingly, for deployment “A,” the schema resolution order may be configured as “shared, deployment_specific_A,” and for deployment “B,” the schema resolution order may be configured as “shared, deployment_specific_B.” The schema resolution unit 204 may determine the appropriate schema resolution order based on the deployment identifier associated with a database connection request.

Configuring schema resolution behavior at the database session level may allow database queries referencing unqualified table names to be resolved automatically by the database engine according to the configured schema order. As a result, application components such as the application server 106 may issue database queries without requiring schema-qualified table references. This approach may allow existing database queries to execute without requiring application-level query rewriting.

The configuration of the schema resolution order may be performed using various mechanisms supported by the database management system 108. For example, the schema resolution unit 204 may configure session properties by setting a default schema or schema search path for the database session. The schema resolution unit 204 may configure session properties by setting a schema search path for the database session that includes the shared schema 112 and the deployment-specific schema 116 corresponding to the deployment associated with the session.

In certain database systems, however, schema search path functionality may not be available or may not support dynamic configuration at the session level. In such implementations, similar schema resolution behavior may be achieved using alternative mechanisms supported by the database management system 108. For example, schema resolution may be implemented by setting a default schema associated with a database user or connection, by defining database objects such as synonyms or views referencing tables in the shared schema 112 and the deployment-specific schemas 116, or by dynamically binding the deployment-specific schema 116 to a database session during connection establishment.

In other examples, schema resolution may be achieved by routing database queries through an intermediary component or query routing proxy configured to apply schema qualification to table names prior to execution of the queries. These alternative mechanisms may allow the schema resolution architecture described herein to be implemented across different database technologies, including systems that do not support configurable schema search paths, while maintaining consistent query resolution

By way of example, in database systems such as Microsoft SQL Server, schema resolution behavior similar to that described herein may be achieved using synonym-based routing. In such implementations, the schema management unit 202 may create database synonyms within a default schema accessible to database sessions, where each synonym references a corresponding table in either the shared schema 112 or the appropriate deployment-specific schema 116. When a database query references an unqualified table name, the database engine may resolve the reference to the synonym, which in turn references the target table in the appropriate schema. For deployment-specific tables, separate synonyms may be created for each deployment, with the appropriate synonym being made accessible to database sessions based on the deployment identity associated with the session. In some implementations, synonym creation and management may be automated by the schema management unit 202 during deployment provisioning and schema updates. In database systems such as Oracle Database, schema resolution behavior may be achieved using session-level schema binding through the ALTER SESSION SET CURRENT_SCHEMA command or equivalent mechanisms. In such implementations, the schema resolution unit 204 may issue schema binding commands at session establishment to set the current schema context for the database session. Tables in the bound schema may then be accessible using unqualified table names. For hybrid schema configurations, the schema resolution unit 204 may configure sessions to access a schema containing views or synonyms that reference tables in both the shared schema 112 and the deployment-specific schema 116, thereby enabling unqualified table name resolution across both schemas. In some aspects, Oracle Database implementations may also utilize the SYNONYM database object to create references from a session-accessible schema to tables stored in shared or deployment-specific schemas, similar to the SQL Server implementation described above.

In operation, database queries generated by the application server 106 in response to requests received from the client systems 102 may be executed using database sessions established between the database management system 108 and the database 104. The database sessions and database connections established between the database management system 108 and the database 104 may be managed by the connection pooler 206. The connection pooler 206 may maintain a pool of reusable database connections and may allocate database connections for sessions associated with respective deployments.

When a database session is established for a deployment, the connection pooler 206 may configure the database session using a schema resolution order determined by the schema resolution unit 204 as explained above. The configured schema resolution order may therefore define the order in which schemas are searched when resolving table references during execution of database queries within the session.

In some implementations, the connection pooler 206 may manage the mapping between deployment identity and schema resolution configuration using various connection management strategies. For example, the connection pooler 206 may maintain separate pools of pre-configured database connections, each pool associated with a respective deployment and having connections pre-configured with the appropriate schema resolution order for that deployment. When a database session is requested for a particular deployment, the connection pooler 206 may allocate a connection from the pool associated with that deployment, thereby avoiding the need to reconfigure the connection at session establishment time. Alternatively, the connection pooler 206 may maintain a shared pool of database connections and dynamically reconfigure connections when assigned to a different deployment. In such implementations, when a connection previously used for a first deployment is reassigned to a second deployment, the connection pooler 206 may issue configuration commands to update the schema resolution order for the connection before the connection is used for the second deployment. In some aspects, the connection pooler 206 may implement connection tagging mechanisms that associate metadata with each connection indicating the deployment for which the connection is currently configured. The connection pooler 206 may use such tags to determine whether a connection requires reconfiguration when allocated for a new database session. In certain implementations, the connection pooler 206 may implement connection affinity strategies that preferentially allocate connections to sessions associated with the same deployment for which the connection was previously configured, thereby reducing the frequency of connection reconfiguration operations. In some cases, the connection pooler 206 may implement lazy reconfiguration, in which schema resolution configuration is deferred until a database query is actually submitted, thereby avoiding unnecessary configuration operations for connections that may be returned to the pool without being used for query execution.

Once a database session is established and configured with the schema resolution order, database queries may be submitted by the application server 106 for execution. In some cases, such queries may reference tables using schema-qualified table names that explicitly identify the schema in which the referenced table is located. In such cases, the table reference may be resolved directly using the schema specified in the query without consulting the schema resolution order. In other cases, queries may include unqualified table names that do not explicitly identify a schema. When such unqualified table names are encountered during query processing, the table reference may be resolved according to the schema resolution order configured for the database session. In particular, the schemas identified in the schema resolution order may be consulted to determine the schema in which the referenced table is located. In an example, the schema resolution order may specify that the shared schema 112 is searched prior to the deployment-specific schema 116, thereby allowing multi-tenant tables stored in the shared schema to be resolved first while still enabling tables stored in the deployment-specific schema corresponding to the deployment to be accessed when a corresponding table does not exist in the shared schema.

Accordingly, it may first be determined whether a table corresponding to the unqualified table name exists within the shared schema 112. If a table with the referenced name exists in the shared schema 112, the unqualified table name may be resolved to the corresponding multi-tenant table stored in the shared schema 112. However, if a table with the referenced name does not exist in the shared schema 112, the unqualified table name may instead be resolved to a corresponding table stored in the deployment-specific schema 116 associated with the deployment corresponding to the current database session.

In some implementations, the database management system 108 may implement error handling mechanisms for situations in which a table name referenced in a database query is not found in either the shared schema 112 or the deployment-specific schema 116 corresponding to the deployment associated with the database session. When schema resolution fails to locate a table matching the referenced table name in any schema identified in the schema resolution order, the database management system 108 may generate an error response indicating that the referenced table does not exist. In some aspects, the database management system 108 may log schema resolution failures, including information identifying the unresolved table name, the deployment associated with the database session, and the schemas that were searched during resolution. Such logging may facilitate diagnosis of configuration errors, missing table definitions, or application queries referencing incorrect table names. In certain implementations, the database management system 108 may be configured to generate alerts when schema resolution failures exceed a threshold frequency, thereby enabling operational personnel to identify and address systematic issues with schema configuration or application queries. In some cases, the database management system 108 may implement graceful degradation strategies in which certain categories of schema resolution failures are handled without terminating the database session, such as by returning empty result sets for queries referencing optional or deprecated tables. Such graceful degradation mechanisms may improve system resilience in scenarios where schema configurations are being updated or where application components reference tables that may not exist in all deployment configurations.

Resolving table references in this manner may allow application queries to access both shared and deployment-specific tables without requiring schema-qualified table references. In an example, the schema resolution mechanism described above may operate without performing runtime dictionary or metadata lookup processes commonly used to determine target schemas for query execution. Instead of consulting routing tables, metadata dictionaries, or external routing services to determine a target schema, the system may rely on the schema resolution order configured for the database session.

Avoiding such runtime lookup operations may reduce query processing overhead and improve scalability as the number of deployments and database objects increases. In conventional multi-tenant database architectures, query execution may require consultation of routing tables, metadata dictionaries, or external routing services to determine the appropriate schema or database for executing a query. Eliminating such runtime routing mechanisms may reduce the number of intermediate processing steps required during query execution, thereby improving query execution latency and reducing computational overhead associated with query routing.

In some implementations, session-level schema resolution may provide performance advantages compared to runtime dictionary or metadata lookup approaches. Because the schema resolution order is configured once at session establishment and persists for the duration of the database session, table name resolution may be performed using database-native schema search mechanisms without requiring additional network round trips, external service calls, or in-memory dictionary consultations for each query. In contrast, runtime dictionary lookup approaches may require consultation of routing tables, metadata services, or in-memory dictionaries for each database query or for each table reference within a query, thereby introducing per-query overhead that scales with query volume. In some aspects, the performance differential between session-level schema resolution and runtime dictionary lookups may become more pronounced as the number of deployments and database objects increases, because dictionary-based approaches may require larger routing tables and longer lookup times as the system scales, whereas session-level schema resolution overhead remains substantially constant regardless of the total number of deployments or tables in the database. In certain implementations, session-level schema resolution may reduce query latency by eliminating intermediate processing steps between query submission and query execution, thereby enabling database queries to be processed with latency characteristics comparable to single-schema database environments. Additionally, session-level schema resolution may reduce computational overhead on application servers or intermediary routing components by offloading table resolution to the database engine, which may be optimized for schema-based object resolution. In some cases, the elimination of runtime routing lookups may also improve system reliability by reducing dependencies on external routing services or metadata stores that could introduce points of failure in the query execution path.

Through the architecture illustrated in FIG. 2, the system 100 may allow multiple deployments to operate within a shared database infrastructure while preserving logical isolation for deployment-specific components. By configuring schema resolution behavior at the database session level, table resolution may be performed deterministically using the schema resolution order associated with the database session. This mechanism may allow existing database queries to execute without modification while eliminating the need for runtime query routing layers or application-level schema rewriting.

Accordingly, the hybrid schema architecture described herein may improve scalability of the database environment, simplify consolidation of multiple deployment databases into a shared database infrastructure, and improve resource utilization of database storage and processing resources. In addition, application components originally designed for single-schema database environments may operate within the hybrid schema database architecture without requiring modification of existing query logic, thereby enabling migration of existing database deployments into shared database environments with reduced operational complexity.

In an example, the hybrid schema architecture described herein may facilitate migration of database environments in which deployments are initially stored in separate databases into a shared database infrastructure implemented by the database 104. During such migration processes, data from individual deployment databases may be consolidated into multi-tenant tables stored in the shared schema 112, while tables requiring deployment-level isolation may be maintained within corresponding deployment-specific schemas 116. Because database queries issued by application components may reference table names without schema qualification, existing application queries may continue to operate without modification following migration. This capability may reduce the operational complexity associated with consolidating multiple deployment databases into a shared infrastructure while preserving compatibility with existing application logic.

In some implementations, the hybrid schema architecture may be integrated with a change data capture (CDC) migration framework to facilitate migration of data from multiple separate database instances into the shared database infrastructure implemented by the database 104. During such migration, a CDC pipeline may capture data changes from source database instances and stream those changes through a message queue or event transport layer to consumer services that write the data into the database 104. As part of the migration process, the schema management unit 202 may provision the shared schema 112 and deployment-specific schemas 116 within the database 104 prior to or concurrently with data migration. Consumer services processing CDC events may apply the deployment-aware identifier encoding described herein to transform application identifiers from source databases into encoded database identifiers suitable for storage in the multi-tenant tables 114 of the shared schema 112. For tables designated for deployment-specific storage, the consumer services may route records to the appropriate deployment-specific schema 116 based on the deployment identifier associated with the source database. During migration, the schema resolution unit 204 may configure schema resolution orders for database sessions such that application components can begin accessing the database 104 while migration is in progress, with queries resolving to tables that have been populated with migrated data. In some aspects, the migration framework may maintain the source database instances in a synchronized state with the database 104 during a transition period, enabling a brief cutover window in which application connections are switched from source databases to the database 104. In certain implementations, a reverse CDC path may be maintained from the database 104 back to the source database instances, enabling rollback to the original database configuration if issues are encountered during or after migration. The reverse CDC path may decode encoded database identifiers back to original application identifiers and route records to the appropriate source database instance based on the deployment identifier embedded in the encoded identifiers.

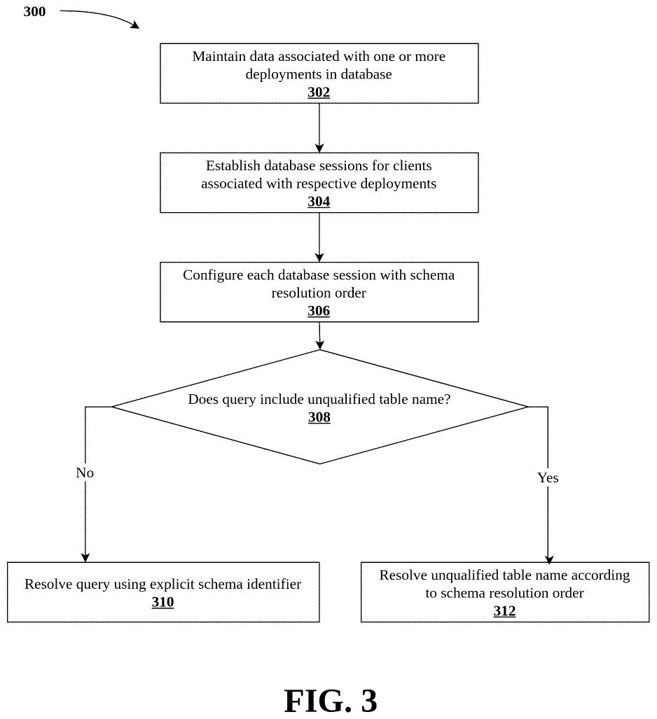

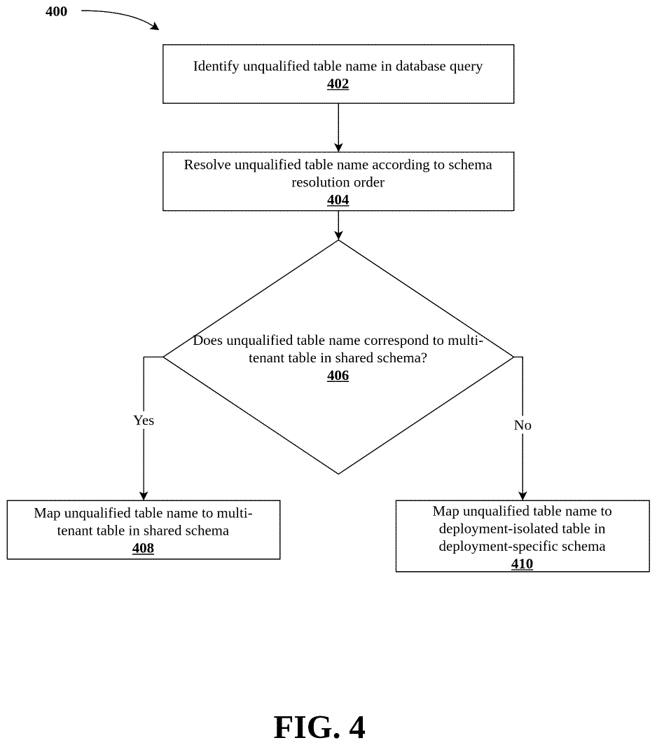

FIG. 3 illustrates a method 300 for managing data associated with one or more deployments using a hybrid schema architecture, and FIG. 4 illustrates method 400 for resolving unqualified table names in database queries. In describing FIG. 3, reference to the description and examples of FIGS. 1-2 should be understood to be part thereof for purposes of illustrating suitable components or elements for performing a step or sub-step being described and for the sake of brevity, the detailed operation of the components or elements has not been repeated herein and will be understood to be associated with the respective step or sub-step being described.

It will be appreciated that some of the method steps may be deleted, modified, or more steps may be added. Also, the steps are not limited by the order in which they are performed. Some of the steps may be performed simultaneously as well.

Referring to FIG. 3 examples of method steps described herein are techniques are performed by the processor executing one or more sequences of software logic instructions that constitute the components of the database management system, the database, or the application server. Such instructions may be read into the memory from machine-readable medium, such as memory storage devices. It is contemplated that, in some implementations, some of the sub-modules, or any other portions of executable instructions constituting the components of the system 100 may be hosted at a remote device. In alternative implementations, at least some hard-wired circuitry may be used in place of, or in combination with, the software logic instructions to implement examples described herein. Thus, the examples described herein are not limited to any particular combination of hardware circuitry and software instructions.

At block 302, data associated with one or more deployments may be maintained in the database 104. In some implementations, the database 104 may include a shared schema 112 storing a plurality of multi-tenant tables accessible by the one or more deployments, and one or more deployment-specific schemas 116. Each deployment-specific schema 116 may correspond to a respective deployment and may store one or more deployment-isolated tables associated with that deployment.

At block 304, database sessions may be established for clients associated with respective deployments. For example, database sessions may be established in response to connection requests generated by client systems or application components associated with a particular deployment.

At block 306, each database session may be configured with a schema resolution order identifying the shared schema 112 and the deployment-specific schema 116 corresponding to the deployment associated with the database session. The schema resolution order may define the order in which schemas are consulted when resolving table references during execution of database queries within the session.

At block 308, it may be ascertained whether a database query received via the database session includes an unqualified table name. As described above, an unqualified table name may correspond to a table name that does not include a schema identifier.

If, at block 308, it is ascertained that the query does not include an unqualified table name, the method 300 may proceed to block 310, where the query may be resolved using the schema identifier explicitly specified in the query.

However, if at block 308 it is ascertained that the query includes an unqualified table name, the method 300 may proceed to block 312, where the unqualified table name may be resolved according to the schema resolution order configured for the database session, as explained further with reference to FIG. 4.

In an example, processing the database queries may further include identifying records stored in tables of the shared schema 112 using encoded database identifiers generated by encoding application identifiers with deployment identifiers associated with respective deployments. In certain implementations, when records are stored in tables of the deployment-specific schemas 116, identification of such records may depend on whether the deployment-specific tables reference tables stored in the shared schema 112. For example, when a deployment-specific table does not reference tables in the shared schema 112, records may be identified using identifiers corresponding to application identifiers generated within the respective deployment. However, when the deployment-specific table references tables in the shared schema 112, records may be identified using encoded database identifiers generated by encoding the application identifiers with deployment identifiers associated with the respective deployments. In some implementations, the deployment-isolated tables stored in the deployment-specific schemas 116 may include scheduler tables or other vendor-controlled tables having predefined table schemas. In addition, the method 300 may further include establishing a hybrid schema structure within the database 104, including generating the shared schema 112 configured to store multi-tenant tables accessible by multiple deployments and generating a deployment-specific schema 116 for each deployment, wherein tables determined to require deployment isolation are generated in the corresponding deployment-specific schemas.

Referring to FIG. 4, a method 400 for resolving unqualified table names in database queries is illustrated. The method 400 may be performed during processing of database queries executed within a database session configured with a schema resolution order as described above. The method 400 may be performed by the database management system 108, in coordination with the database 104.

At block 402, an unqualified table name included in a database query may be identified. As described previously, an unqualified table name may correspond to a table name that does not include a schema identifier.

At block 404, the unqualified table name may be resolved according to the schema resolution order configured for the database session. In some implementations, the schema resolution order may specify that the shared schema 112 is consulted prior to the deployment-specific schema 116 corresponding to the deployment associated with the database session. For example, a deployment with identifier “1234” may have a schema resolution order configured as “shared, deployment_specific_1234”. Further, a scheduler query may reference a table named “QRTZ_SCHEDULER_STATE” without specifying whether the table resides in the shared schema or a deployment-specific schema.

At block 406, it may be ascertained whether the unqualified table name corresponds to a multi-tenant table stored in the shared schema 112. If the unqualified table name corresponds to a multi-tenant table stored in the shared schema 112, the method 400 may proceed to block 408, where the unqualified table name may be mapped to the multi-tenant table stored in the shared schema 112. For example, if a query references a table named “customers” and a table with that name exists in the shared schema, the query may access the multi-tenant “customers” table that is shared across all deployments.

If the unqualified table name does not correspond to a multi-tenant table stored in the shared schema 112, the method 400 may proceed to block 410, where the unqualified table name may be mapped to a deployment-isolated table stored in the deployment-specific schema 116 corresponding to the deployment associated with the database session. For example, if a query references a table named “scheduler_jobs” and no table with that name exists in the shared schema, the query may access the “scheduler_jobs” table in the deployment-specific schema associated with the deployment (e.g., deployment_specific_A).

Such resolution process may occur transparently without requiring modification to the database queries issued by client applications. As a result, application components may continue to issue database queries using unqualified table names while table resolution is performed according to the schema resolution order configured for the database session.

Further, resolving the unqualified table names may be performed without performing a runtime lookup process used to determine a target schema for execution of the database query. Such runtime lookup processes may include runtime metadata lookups, dictionary lookups, or routing table lookups commonly used in conventional multi-tenant database architectures. Instead, table resolution may rely on the schema resolution order configured for the database session, thereby enabling deterministic schema selection during query processing. This resolution approach may allow vendor-controlled components, such as job scheduling subsystems or similar components that issue predefined database queries, to operate using their standard database queries while the database management system performs schema resolution according to the configured schema resolution order.

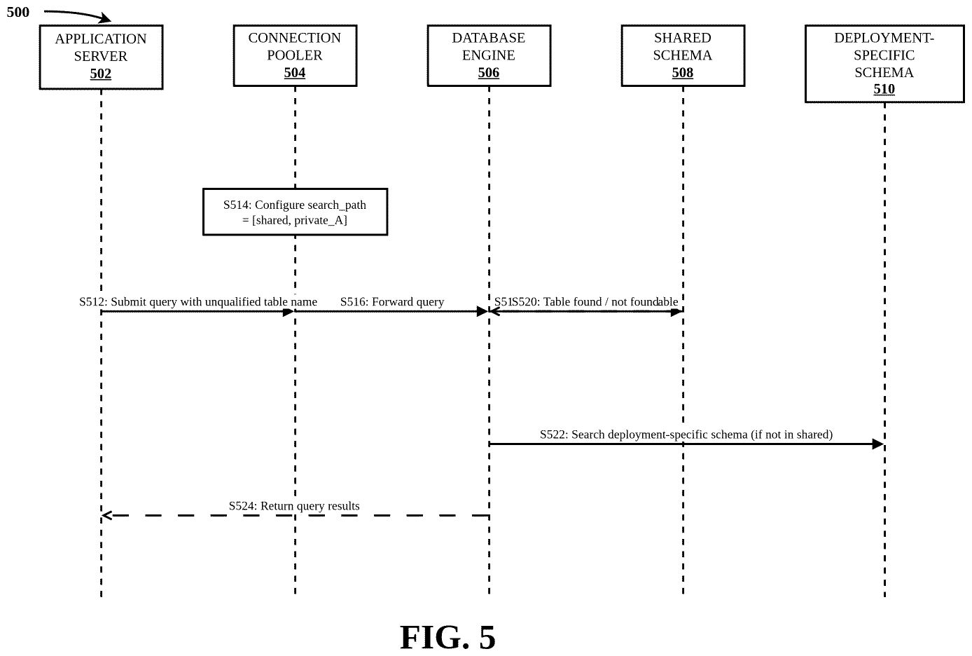

FIG. 5 illustrates, in an example embodiment, a sequence diagram of a process 500 for query resolution using schema search path configuration. The process 500 involves interactions among an application server 502, a connection pooler 504, a database engine 506, a shared schema 508, and a deployment-specific schema 510. At step S512, the application server 502 submits a query with an unqualified table name to the connection pooler 504. At step S514, the connection pooler 504 configures the search_path for the database session to include the shared schema and the deployment-specific schema corresponding to the deployment associated with the session. For example, for a deployment having identifier “A,” the search_path may be configured as [shared, private_A]. At step S516, the connection pooler 504 forwards the query to the database engine 506 for execution. At step S518, the database engine 506 searches the shared schema 508 for a table matching the unqualified table name referenced in the query. At step S520, the shared schema 508 returns an indication of whether the referenced table was found or not found. At step S522, if the table was not found in the shared schema 508, the database engine 506 searches the deployment-specific schema 510 for a table matching the unqualified table name. At step S524, the database engine 506 returns the query results to the application server 502. In this manner, the process 500 illustrates how schema resolution may be performed transparently using the configured search_path without requiring modification of the database queries issued by the application server 502.

The search_path configuration approach illustrated in FIG. 5 may provide several advantages for query processing in hybrid schema environments. Because the search_path is configured at the connection or session level, the schema resolution behavior persists for the duration of the database session without requiring per-query configuration. This approach may reduce overhead compared to mechanisms that require schema determination for each individual query. In addition, the search_path configuration leverages database-native schema resolution capabilities, allowing the database engine 506 to perform table name resolution using optimized internal mechanisms rather than external routing components or application-level query rewriting.

In some implementations, the sequence illustrated in FIG. 5 may vary depending on whether the referenced table exists in the shared schema 508 or the deployment-specific schema 510. When the table exists in the shared schema 508, the database engine 506 may resolve the table reference at step S518 and proceed directly to query execution without searching the deployment-specific schema 510. When the table does not exist in the shared schema 508, the database engine 506 may proceed to step S522 to search the deployment-specific schema 510. This fallback behavior enables application queries to access both shared multi-tenant tables and deployment-isolated tables using the same unqualified table name syntax, with the schema resolution order determining which table is accessed based on the configured search_path.

The process 500 may also integrate with connection pooling and session management mechanisms implemented by the connection pooler 504. In some aspects, the connection pooler 504 may maintain pools of database connections pre-configured with search_path settings corresponding to different deployments. When a query is received from the application server 502, the connection pooler 504 may allocate a connection from the appropriate pool based on the deployment identity associated with the request. In other implementations, the connection pooler 504 may dynamically configure the search_path at step S514 when a connection is assigned to a session associated with a different deployment than the connection was previously configured for. Such dynamic reconfiguration may enable efficient connection reuse across deployments while maintaining correct schema resolution behavior for each session.

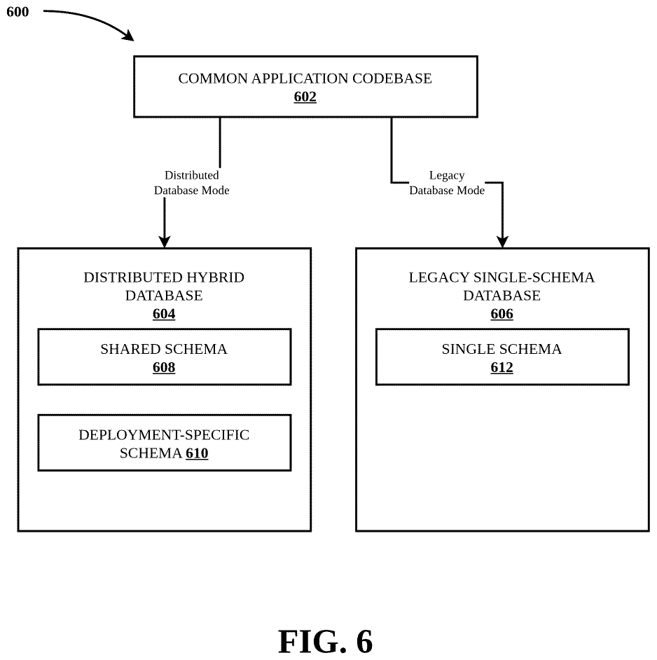

FIG. 6 illustrates, in an example embodiment, a dual-mode configuration 600 showing a common application codebase 602 operating with both hybrid-schema and legacy single-schema database environments. The configuration 600 demonstrates how the same application codebase may interact with different database configurations without requiring modification of application queries or database interaction logic. In a distributed database mode, the common application codebase 602 connects to a distributed hybrid database 604, which includes a shared schema 608 and a deployment-specific schema 610. In this mode, database sessions may be configured with a schema resolution order that includes both the shared schema 608 and the deployment-specific schema 610, enabling unqualified table names to be resolved according to the configured search order. In a legacy database mode, the common application codebase 602 connects to a legacy single-schema database 606, which includes a single schema 612 containing all tables associated with a deployment. In this mode, database sessions may access the single schema 612 using default schema behavior or a search path configured with only the single schema. The dual-mode configuration 600 may allow applications originally designed for single-schema databases to operate within hybrid schema database environments, and may facilitate migration of existing systems to shared database infrastructures while maintaining compatibility with legacy deployments that continue to operate using conventional single-schema databases.

In some implementations, the common application codebase 602 may detect or be configured to operate in either the distributed database mode or the legacy database mode based on configuration parameters, environment variables, or database connection properties. For example, the application codebase 602 may inspect database metadata or connection settings at startup to determine whether the connected database supports the hybrid schema architecture. Alternatively, deployment configuration may explicitly specify the database mode, allowing the application codebase 602 to adjust its connection initialization behavior accordingly. In the distributed database mode, the application codebase 602 may configure database sessions with a schema resolution order including both the shared schema 608 and the deployment-specific schema 610. In the legacy database mode, the application codebase 602 may configure database sessions to access the single schema 612 using default schema behavior or a simplified search path.

The dual-mode configuration 600 may facilitate migration scenarios in which systems transition from legacy single-schema databases to distributed hybrid schema environments. During such migrations, the common application codebase 602 may initially operate in the legacy database mode against existing single-schema databases. As deployments are migrated to the distributed hybrid database 604, the application codebase 602 may be reconfigured to operate in the distributed database mode without requiring modification of application queries or database interaction logic. This capability may enable phased migration strategies in which individual deployments are migrated incrementally while the application codebase 602 continues to support both migrated and non-migrated deployments.

Supporting both the distributed database mode and the legacy database mode within a single application codebase may reduce development and maintenance overhead compared to maintaining separate codebases for different database configurations. Application developers may implement database interaction logic once using unqualified table names, and the schema resolution behavior configured for each database mode may ensure that queries are resolved to the appropriate tables regardless of the underlying database architecture. This approach may also simplify testing and validation, as the same application logic may be tested against both hybrid schema and single-schema database configurations to verify consistent behavior across deployment environments.

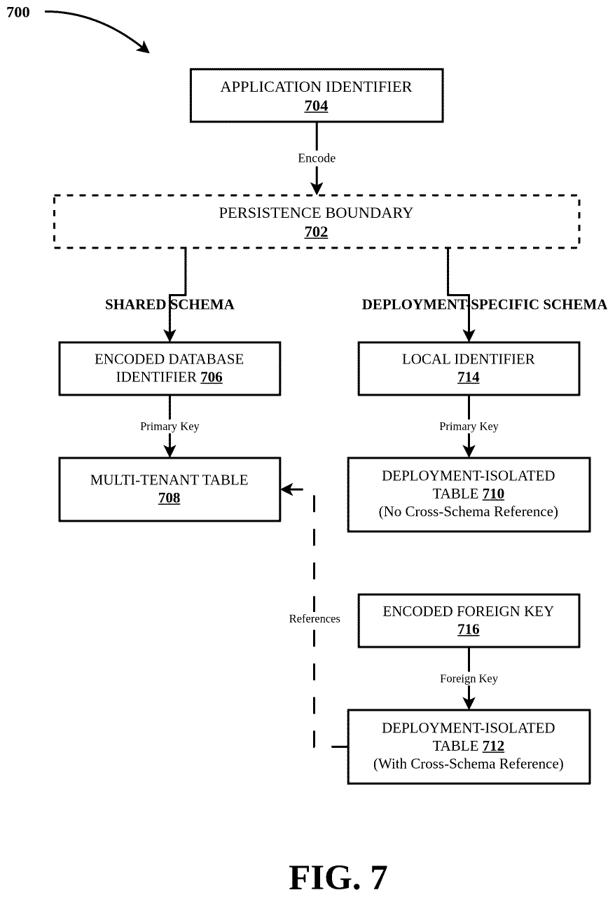

FIG. 7 illustrates, in an example embodiment, an encoded identifier handling architecture 700 that demonstrates how identifiers are processed at a persistence boundary 702 between application logic and the database. An application identifier 704 generated by application logic is processed through the persistence boundary 702, which encodes the application identifier into different identifier formats depending on the target storage location. For tables stored in the shared schema, the persistence boundary 702 generates an encoded database identifier 706 by encoding the application identifier 704 with a deployment identifier associated with the deployment from which the record originates. The encoded database identifier 706 serves as a primary key in a multi-tenant table 708 stored in the shared schema, enabling records from multiple deployments to coexist within the same table without identifier collisions. For tables stored in the deployment-specific schema that do not reference tables in the shared schema, the persistence boundary 702 may generate a local identifier 714 corresponding to the application identifier generated within the respective deployment. The local identifier 714 serves as a primary key in a deployment-isolated table 710 that has no cross-schema references. For tables stored in the deployment-specific schema that reference tables in the shared schema, the persistence boundary 702 may generate an encoded foreign key 716 that references records in the multi-tenant table 708. The encoded foreign key 716 serves as a foreign key in a deployment-isolated table 712 that has cross-schema references to the multi-tenant table 708. In this manner, the architecture 700 enables consistent identifier handling across both shared multi-tenant tables and deployment-isolated tables within the hybrid schema architecture, while allowing application business logic to continue operating using simple application-level identifiers without awareness of the underlying encoded representation stored in the database.

The persistence boundary 702 illustrated in FIG. 7 may perform encoding and decoding operations transparently during database read and write operations. When application logic creates a new record, the persistence boundary 702 may intercept the write operation and encode the application identifier 704 into the appropriate identifier format based on the target table location. For records destined for multi-tenant tables in the shared schema, the persistence boundary 702 may generate the encoded database identifier 706 by combining the application identifier 704 with a deployment identifier using deterministic bit-manipulation operations. For records destined for deployment-isolated tables without cross-schema references, the persistence boundary 702 may pass through the application identifier as the local identifier 714 without encoding. When reading records from the database, the persistence boundary 702 may decode encoded database identifiers back to application identifiers, allowing application logic to operate using simple application-level identifiers without awareness of the underlying encoding.

The architecture 700 may handle different identifier scenarios depending on the nature of the database operation and the relationships between tables. For new records inserted into multi-tenant tables, the persistence boundary 702 may generate encoded database identifiers that embed the deployment identifier, ensuring that records from different deployments do not collide even when the original application identifiers overlap. For existing records read from the database, the persistence boundary 702 may decode the encoded database identifiers to recover the original application identifiers for use by application logic. For cross-schema references, such as when a deployment-isolated table 712 references a record in the multi-tenant table 708, the persistence boundary 702 may generate encoded foreign keys 716 that maintain referential integrity across schemas while preserving the ability to decode identifiers when needed.

The encoded identifier handling architecture 700 may enable migration of existing data from separate deployment databases into the shared database infrastructure without requiring modification of application-level identifier values. When deployment databases with overlapping primary key ranges are consolidated into the shared schema, the persistence boundary 702 may encode the original application identifiers with deployment identifiers to produce globally unique encoded database identifiers. This approach may allow records that previously had identical primary keys in separate databases to coexist within the same multi-tenant table without collisions. During migration, the encoding may be applied to historical data as it is transferred to the shared database, and subsequent application operations may continue using the original application identifiers while the persistence boundary 702 transparently handles encoding and decoding at the database interface.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, the absence of describing combinations should not preclude the inventor from claiming rights to such combinations.

1. A system comprising:
a processor; and
a memory including instructions executable in the processor to:
maintain a shared schema in a database, the shared schema storing a plurality of multi-tenant tables accessible by one or more deployments;
maintain one or more deployment-specific schemas in the database, each deployment-specific schema corresponding to a respective deployment of the one or more deployments and storing one or more deployment-isolated tables associated with the respective deployment;
establish database sessions for clients associated with respective deployments;
configure each database session with a schema resolution order identifying the shared schema and the deployment-specific schema corresponding to the deployment associated with the database session; and
process database queries received via the database session by resolving unqualified table names, wherein an unqualified table name corresponds to a table name that does not include a schema identifier according to the schema resolution order, wherein the resolving comprises:
ascertaining whether the unqualified table name corresponds to a multi-tenant table stored in the shared schema;
when the unqualified table name corresponds to the multi-tenant table stored in the shared schema, mapping the unqualified table name to the multi-tenant table stored in the shared schema; and
when the unqualified table name does not correspond to the multi-tenant table stored in the shared schema, mapping the unqualified table name to a deployment-isolated table in the deployment-specific schema corresponding to the deployment associated with the database session.

2. The system of claim 1, wherein the schema resolution order specifies that the shared schema is searched prior to the deployment-specific schema corresponding to the deployment associated with the database session.

3. The system of claim 1, wherein configuring the schema resolution order comprises one or more of:
setting a default schema for the database session;
defining one or more database objects comprising synonyms referencing tables in at least one of the shared schema and the deployment-specific schema;
dynamically binding the deployment-specific schema to the database session at connection establishment; and
routing database queries through an intermediary component configured to apply schema qualification to table names prior to execution of the database queries.

4. The system of claim 1, wherein resolving the unqualified table names is performed without performing a runtime lookup process used to determine a target schema for execution of a database query, the runtime lookup process comprising one or more of a runtime metadata lookup, a dictionary lookup, or a routing table lookup.

5. The system of claim 1 further comprising an application server configured to generate the database queries using a common application codebase that operates with both a distributed database mode including the shared schema and the one or more deployment-specific schemas, and a legacy database mode including tables associated with a deployment stored in a single schema.

6. The system of claim 1, wherein the system is further configured to apply schema changes to the database, wherein the schema changes comprise:
a first set of changesets applied to the shared schema, the first set of changesets comprising common schema changes; and
a second set of changesets applied to the deployment-specific schemas corresponding to respective deployments, the second set of changesets comprising component-specific schema changes.

7. The system of claim 1, wherein processing of the database queries comprises identifying a record stored in a table of the shared schema using encoded database identifiers, the encoded database identifiers being generated by encoding application identifiers with deployment identifiers associated with respective deployments.

8. The system of claim 1, wherein processing of the database queries comprises identifying records stored in tables of the database comprising:
identifying records stored in tables of the deployment-specific schemas using identifiers corresponding to application identifiers generated within the respective deployments; and
identifying records stored in tables of the deployment-specific schemas that reference tables in the shared schema using encoded database identifiers generated by encoding the application identifiers with deployment identifiers associated with the respective deployments.

9. The system of claim 1, wherein the one or more deployment-isolated tables stored in the deployment-specific schemas comprise scheduler tables having a vendor-controlled table schema.

10. The system of claim 1 is further configured to establish a hybrid schema structure in the database, the establishing comprising:
generating the shared schema configured to store multi-tenant tables accessible by the one or more deployments; and
generating a deployment-specific schema for each deployment, wherein tables determined to require deployment isolation are generated in the deployment-specific schemas corresponding to the respective deployments.

11. A computer-implemented method comprising:
maintaining data associated with one or more deployments in a database, the database comprising:
a shared schema storing a plurality of multi-tenant tables accessible by the one or more deployments; and
one or more deployment-specific schemas, each deployment-specific schema corresponding to a respective deployment of the one or more deployments and storing one or more deployment-isolated tables for the respective deployment;
establishing database sessions for clients associated with respective deployments;
configuring each database session with a schema resolution order identifying the shared schema and the deployment-specific schema corresponding to the deployment associated with the database session; and
processing database queries received via the database session by resolving unqualified table names, wherein an unqualified table name corresponds to a table name that does not include a schema identifier according to the schema resolution order, and wherein resolving the unqualified table names comprises:
ascertaining whether the unqualified table name corresponds to a multi-tenant table stored in the shared schema;
when the unqualified table name corresponds to the multi-tenant table stored in the shared schema, mapping the unqualified table name to the multi-tenant table stored in the shared schema; and
when the unqualified table name does not correspond to the multi-tenant table stored in the shared schema, mapping the unqualified table name to a deployment-isolated table in the deployment-specific schema corresponding to the deployment associated with the database session.

12. The method of claim 11, wherein the schema resolution order specifies that the shared schema is searched prior to the deployment-specific schema corresponding to the deployment associated with the database session.

13. The method of claim 11, wherein configuring the schema resolution order comprises one or more of:
setting a default schema for the database session;
defining one or more database objects comprising synonyms referencing the tables in at least one of the shared schema or the deployment-specific schema;
dynamically binding the deployment-specific schema to the database session at connection establishment; and
routing database queries through an intermediary component configured to apply schema qualification to table names prior to execution of the database queries.

14. The method of claim 11, wherein resolving the unqualified table names is performed without performing a runtime lookup process used to determine a target schema for execution of a database query, the runtime lookup process comprising one or more of a runtime metadata lookup, a dictionary lookup, or a routing table lookup.

15. The method of claim 11, further comprising generating the database queries using an application server executing a common application codebase configured to operate with both:
a distributed hybrid database mode including the shared schema and the one or more deployment-specific schemas; and
a legacy database mode including tables associated with a deployment stored in a single schema.

16. The method of claim 11, further comprising applying schema changes to the database, wherein the schema changes comprise:
a first set of changesets applied to the shared schema, the first set of changesets comprising common schema changes; and
a second set of changesets applied to the deployment-specific schemas corresponding to respective deployments, the second set of changesets comprising component-specific schema changes.

17. The method of claim 11, wherein processing the database queries comprises identifying a record stored in a table of the shared schema using encoded database identifiers, the encoded database identifiers being generated by encoding application identifiers with deployment identifiers associated with respective deployments.

18. The method of claim 11, wherein processing the database queries comprises identifying a record stored in a table of a deployment-specific schema, the identification comprising:
when the table does not reference tables in the shared schema, identifying the record using identifiers corresponding to application identifiers generated within the respective deployments; and
when the table references the tables in the shared schema, identifying the record using encoded database identifiers generated by encoding the application identifiers with deployment identifiers associated with the respective deployments.

19. The method of claim 11, wherein the one or more deployment-isolated tables stored in the deployment-specific schemas comprise scheduler tables having a vendor-controlled table schema.

20. The method of claim 11, further comprising establishing a hybrid schema structure in the database, the establishing comprising:
generating the shared schema configured to store multi-tenant tables accessible by the one or more deployments; and
generating a deployment-specific schema for each deployment, wherein tables determined to require deployment isolation are generated in the deployment-specific schemas corresponding to the respective deployments.
